(19) United States
(12) Patent Application Publication
(10) Pub. No.: US 2007/0141442 A1
(43) Pub. Date: Jun. 21, 2007

(54) Fuel cell system

(75) Inventor: Guenther Schlerf, Graefelfing (DE)

Correspondence Address: CROWELL & MORING LLP;INTELLECTUAL PROPERTY GROUP, P.O. BOX 14300, WASHINGTON, DC, 20044-4300, US

(73) Assignee: Bayerische Motoren Werke Aktiengesellschaft, Muenchen (DE)

(21) Appl. No.: 11/704,268

(22) Filed: Feb. 9, 2007

Related U.S. Application Data
(63) Continuation of application No. PCT/EP05/07114, filed on Jul. 1, 2005.

(30) Foreign Application Priority Data
Aug. 12, 2004 (DE) 10 2004 039 308.7
Oct. 6, 2004 (DE) 10 2004 048 526.7

(51) Int. Cl. H01M 8/24; H01M 8/04

(52) U.S. Cl. 429/38; 429/26

(57) ABSTRACT

The invention relates to a fuel cell system having a plurality of individual fuel cells connected in series electrically, each having a cathode-electrolyte-anode unit arranged between an electrically conducting carrier element and an electrically conducting cover element, the side facing the carrier element being acted upon by a first gas and the side facing the cover element being acted upon by a second gas, whereby the individual cells are arranged essentially side by side so that their cathode-electrolyte-anode units that are spaced a distance apart essentially describe a common surface and whereby for two neighboring individual cells, the carrier element of the second individual cell is not only electrically connected to the cover element of the first individual cell but also forms a one-piece component. Various embodiments are described, whereby this fuel cell system preferably has a heat transfer connection to the exhaust system and/or the exhaust gases of an internal combustion engine that drives a motor vehicle.

### CROSS-REFERENCE TO RELATED APPLICATIONS

This application is a continuation of International Patent Application No. PCT/EP2005/007114 filed Jul. 1, 2005 which claims benefit to German patent application Serial No. 10 2004 039 308.7 filed Aug. 12, 2004 and German patent application Serial No. 10 2004 048 526.7 filed Oct. 6, 2004 the entire disclosures of which are hereby incorporated in their entirety.

### FIELD OF THE INVENTION

The invention relates to a fuel cell system having several individual fuel cells connected in series electrically, each having a cathode-electrolyte-anode unit situated between an electrically conducting carrier element and an electrically conducting cover element. One side of this unit faces the carrier element being acted upon by a first gas and another side faces the cover element being acted upon by a second gas, whereby the individual cells that are electrically connected in series are arranged essentially side-by-side so that their cathode-electrolyte-anode units which are spaced a distance apart from one another essentially do not overlap in a perpendicular projection onto same. Considering two individual cells directly adjacent to one another, the cover element of the first individual cell is electrically connected to the carrier element of the second cell. Fuel cells are shown in FR-A-1 585 403 and in addition to EP 1 258 936 A2 (U.S. Pat. No. 6,869,713) the substance of which is incorporated by reference herein.

### BACKGROUND AND SUMMARY OF THE INVENTION

Fuel cells are known as electrochemical energy converters that convert chemical energy directly into electric current; various systems are known, including solid oxide fuel cell (SOFC). In one embodiment, fuel is supplied continuously to one fuel cell or preferably several individual fuel cells on the anode side and oxygen and/or air is supplied continuously on the cathode side. Generally the device provides for spatial separation of the reactants by an electrolyte which is conductive for ions or protons but not for electrons. Corresponding oxidation reactions therefore take place at different locations, namely at the anode and also at the cathode. Thus, the electron exchange induced between the reactants takes place via an external circuit. To this extent the fuel cell is part of a circuit.

A fuel cell comprises several parallel or series-connected individual cells, depending on the desired power and voltage, each individual cell consisting of a cathode-electrolyte-anode unit (CEA). The individual cells are usually joined together by means of electrically conducting end plates or intermediate plates (so-called bipolar plates) and combined to form a stack. In conventional concepts of fuel cell stacks, the gaseous reactants can be distributed on the electrode surfaces of the reactive layers, e.g., via grooves cut in the bipolar plates. In the present disclosure, which relates primarily to an SOFC, i.e., a solid oxide fuel cell system, but is explicitly not limited to an SOFC, as will be apparent from the further description, instead of bipolar plates, carrier elements and cover elements are provided, with a cathode-electrolyte unit situated between each pair of elements. The cathode-electrolyte-anode unit of an individual fuel cell is preferably (but not necessarily) carried by a so-called carrier element, i.e., such that the aforementioned ion exchange can always take place exclusively via the electrolyte layer, while the so-called cover element establishes the electric connection between this individual fuel cell and the next (neighboring) individual fuel cell.

An SOFC has a relatively high operating temperature on the order of 650° C. to 1000° C. and must first be brought to this temperature level to achieve good efficiency. A preferred and/or interesting area of application for SOFCs is in automotive engineering as a generator of electric current for the vehicle electric system and/or for electric loads in the motor vehicle, which may be driven by an internal combustion engine (in the usual manner). For example, it is known from DE 199 13 795 C1 that the exhaust gas of the internal combustion engine can be used to heat the fuel cell system.

However, efficient heat transfer from the exhaust gases of the internal combustion engine to a conventional fuel cell stack is relatively complex. For such an application, a fuel cell design according to the invention is provided, wherein, a fuel cell system comprises several individual fuel cells connected in series electrically, each having a cathode-electrolyte-anode unit arranged between an electrically conducting carrier element and an electrically conducting cover element, with a side facing the carrier element that is acted upon by a first gas (G) and a side facing the cover element that is acted upon by a second gas (L), wherein the individual cells connected in series electrically are arranged side by side so that their cathode-electrolyte-anode units which are spaced a distance apart from one another do not overlap, and wherein considering two individual cells directly adjacent to one another, the cover element of one individual cell is electrically connected to the carrier element of the other individual cell, wherein the surface areas of the cathode-electrolyte-anode units of successive following individual cells increase in the direction of flow of the combustible gas stream (G). Advantageous refinements are also provided by the present invention disclosure.

According to this invention, the areas and/or surfaces of the cathode-electrolyte-anode units of successively following individual cells increase in the direction of flow of the combustible gas stream. As such, the decreasing concentration of the combustible gas stream in the direction of flow can be compensated. The individual cells situated “farther to the rear” in the direction of flow thus have a larger reactive surface area to compensate for the decreasing concentration of the combustion gas stream. Before explaining this with the preferred exemplary embodiments provided in the accompanying FIGS. 2 and 5, reference is first made to an advantageous embodiment of the inventive fuel cell system.

Flat individual fuel cells whose flat design is defined by the area of the cathode-electrolyte-anode unit, are arranged essentially side by side. However, they may also be arranged “one above the other” as explained in greater detail. In one embodiment, the individual cells are essentially arranged side by side so that the cathode-electrolyte units essentially do not cover one another in a perpendicular direction from the same so that an interleaving of the individual fuel cells resembling an arrangement of roofing tiles can be achieved. The arrangement may be such that the cathode-electrolyte units of the individual cells adjacent to one another essentially provides a common surface, but it is also possible to arrange the individual cells that are arranged side by side at an inclination with respect to a longitudinal orientation derived from these individual cells arranged side by side, each by a certain angle. Preferably, the angle should not exceed approximately 45°. For two directly adjacent individual fuel cells the carrier element of the first individual cell is connected to the cover element of the second individual cell in an electrically conducting manner. A row of individual cells arranged side by side approximately in the form of a zigzag line may provided. In these arrangements, when all the cathode-electrolyte-anode units are arranged in a plane, the electric connection between the individual cells is approximately and/or essentially in the same plane as the individual cells themselves and/or as their cathode-electrolyte-anode units.

Such an arrangement of the individual cells essentially side by side increases the “free” surface area of the fuel cell system, so that a transfer of heat for heating the system in particular can take place more easily and more efficiently than in the case of a fuel cell stack. Cooling (if required) and/or constant temperature regulation of a system having a larger system surface area also implemented more easily and in an advantageous manner.

In addition to these advantages of the inventive fuel cell system, the system also provides additional advantages. With an essentially flat arrangement of individual fuel cells, the respective gas stream guided to the cathode-electrode-anode units, which may be air or oxygen and/or a suitable combustible gas (e.g., hydrogen), can be distributed more readily, and in particular in a more advantageous manner from the standpoint of flow through the cathode-electrolyte anode units and/or through the respective carrier element and/or cover element. With the conventional fuel cell stacks, complex so-called manifolds, i.e., gas distributors, are required for this, but with the inventive fuel cell system with essentially individual cells arranged in one plane, a bordering wall running parallel to the carrier elements and/or cover elements, for example, guides the respective gas stream between individual cells arranged side by side between said bordering wall and the carrier elements and/or cover elements of the individual cells arranged side by side. Suitable flow guidance devices may also be present in this bordering wall, but the requirements here pertaining to imperviousness are significantly lower than those with the manifolds of the known fuel cell stacks.

With a fuel cell stack in combination with the aforementioned manifolds, absolutely reliable seals between the two different gas streams (combustion gas and atmospheric oxygen) are required on the respective individual cells because these gas streams must not be allowed to come in direct contact. In an arrangement of the individual cells side by side such as that described here, these individual cells themselves and/or their interconnection functions as a seal, so that no more complex sealing measures are required. This includes the sealing measures required for the distribution of the gases brought to the cathode-electrolyte-anode units. In this sense, the individual cells arranged side by side may be joined together in an airtight manner. Thus, in addition to the improvement already mentioned with regard to the flow guidance of the gases reacting at the cathode-electrolyte-anode units, another advantage of such a fuel cell system consists of a fundamentally simplified design. The number of seals required between the individual cells, and those for the respective gas feeds, can be reduced to a minimum.

In addition to the electrically conducting connection to a carrier element of a neighboring second individual cell which is already functionally present over the cover element of a first cell, there may also be an airtight connection between the carrier element of the first individual cell and the carrier element of the second neighboring individual cell. This second connection must be designed to be electrically insulated to avoid generating a short circuit within the fuel cell. If the second airtight connection is at the same time a mechanical connection, this imparts the required stability to the fuel cell system. Another advantage of such an inventive fuel cell system is the freedom in the design and/or construction of the system achieved in this way. With regard to shape, it may be adapted for to more possible installation sites (e.g., in a motor vehicle) than is possible with the conventional fuel cell stack.

In one embodiment, considering two adjacent cells, the cover element of the first individual cell which is electrically connected to the carrier element of the second individual cell, is designed as a one-piece carrier element-cover element unit together with said carrier element of the second individual cell. This unit provides a step, for example, and/or has an offset in general in a longitudinal section between the two individual cells. The electric connection of the carrier elements and the cover element, which are designed as electric conductors anyway, is implemented in a particularly simple manner and at the same time the number of required mechanical connections in an inventive fuel cell system is kept as low a possible in this way. Advantageously, no additional seal is required to separate the two gas streams from one another in this transitional area from the cover element of the first individual cell to the cover element of the second individual cell. Thus, an airtight connection between the carrier element of the first individual cell and the carrier element of the second neighboring individual cell exists as described further above. Said step design and/or design having an offset in general makes it possible to arrange the neighboring individual cells and/or their cathode-electrolyte-anode units essentially in a “common” surface this common surface need not be a plane. Instead a curved surface may also be implemented.

The common surface of the cathode-electrolyte-anode units may thus be curved in at least one direction and may described essentially by a cylinder or cone. For example, the units may be arranged as a hollow body that is closed in the circumferential direction in general and may be, for example, an essentially rotationally symmetrical body. This allows mounting in and/or on the exhaust system of a motor vehicle in a simple and functionally effective manner. For example, a suitably designed fuel cell system may be integrated into the housing of an exhaust gas catalyst or a shock absorber in the vehicle exhaust system. If necessary, the fuel cell system and/or a bordering wall thereof (already mentioned) itself may be designed as a gas carrying component (for the exhaust gas of the internal combustion engine). Here again, there is an advantage for such an inventive fuel cells system, namely the fact that at least one of the gas streams can be guided very easily along the rows of individual cells, essentially in the longitudinal direction of the individual cells aligned in rows.

In the case of an SOFC with individual fuel cells arranged side by side on a curved surface, it may be advantageous if the ceramic cathode-electrolyte-anode unit is applied to the carrier element partially and/or with an interruption in the area. This avoids creating an excessively large cohesive curved surface which could be critical with regard to thermally induced changes in shape for the electrode ceramic (of the cathode and/or anode) and/or for the electrolyte. For example, the electrodes (cathode and/or anode) and the electrolyte may be applied to the carrier element by a thermal coating method (plasma spraying, etc.; see, for example, WO 02/101859 (U.S. Publication No. 2004/185326 A1)). This could be done not in a cohesive layer but instead with interruptions, whereby passages in the carrier element or cover element are provided in the area of the electrode ceramic through which the respective gas can reach the respective electrode surface.

A mechanical connection between two neighboring carrier element-cover element units has already been mentioned, but these units need not be electrically insulated from one another to prevent an electric short circuit within the fuel cell system. A simple reliable mechanical connection with the insertion of a suitable electric insulation layer, e.g., in the form of a flange is also possible. A gas-carrying bordering wall as mentioned above may also be connected to a carrier element or a cover element via a flange, whereby here again, to prevent a short circuit, suitable insulation is required. However, the mechanical connection between two neighboring carrier element-cover element units and/or between one carrier element-cover element unit and a gas-carrying bordering wall may also be designed in the form of a partial overlap, secured by means of a tension belt or the like, optionally in combination with a supporting element.

Despite the enormous advantages of such a fuel cell system, reference should also be made to a minor disadvantage, namely the fact that relatively long electric current paths are established with this proposed arrangement. When using a suitable (especially with regard to the combustion gas and the high temperatures) resist material for the carrier element-cover element units, this may result in a relatively high electric resistance in the fuel cell system, which is unfavorable. As an expedient, measures can be taken on the cover elements (or carrier elements) of the cathode-electrolyte-anode units, especially those facing the air-oxygen gas stream, to increase the electric conductivity. For example, a suitable highly conductive layer may be applied to these elements.

### BRIEF DESCRIPTION OF THE DRAWINGS

Features and advantages of the present invention will become apparent to those skilled in the art from the following description with reference to the drawings, in which:

FIG. 1 shows a section through two individual fuel cells of a fuel cell system arranged side by side (in one surface);

FIG. 2 shows the upper half of a (curved) cylindrical surface in which individual fuel cells are arranged one after the other in a three-dimensional diagram;

FIG. 3 shows a diagram like that in FIG. 1, illustrating a modified arrangement of individual cells;

FIG. 4 shows a different mechanical joining technique for the cells, which may, for instance, be used in an arrangement like that of FIG. 2;

FIG. 5 illustrates the subdivision of the cathode-electrolyte-anode unit of an individual fuel cell which is already subdivided into areas in the exemplary embodiment according to FIG. 2;

FIG. 6 shows a modification of the embodiment according to FIG. 2;

FIGS. 7a and 7b further expand on the fuel cell system according to FIG. 2 with gas-carrying bordering walls and a gas feed for regulating the temperature of the system, in particular, FIG. 7a shows a longitudinal section through the system and FIG. 7b shows a cross section through the system.

### DETAILED DESCRIPTION OF THE DRAWINGS

The invention is explained in greater detail below on the basis of exemplary embodiments that are presented abstractly (and only in part). Reference is made in particular to FIGS. 2 and 5, where some characterizing features are depicted explicitly. Additional features proposed here are also shown in other figures.

With reference to FIG. 1, a cathode-electrolyte-anode unit 2 is part of an oxide ceramic individual fuel cell 1. This cathode-electrolyte-anode unit 2 is applied to a carrier element 3 which consists here of a metallic base plate 3a with metallic mesh 3b positioned on top of it and the first ceramic electrode layer 2a of the cathode-electrolyte-anode unit 2 namely anode 2a is applied to this metallic mesh by plasma spraying or the like. Then an electrolyte layer 2b is applied to this anode 2a and the second ceramic electrode layer 2c namely cathode 2c, is applied to this electrolyte layer, as described in WO 02/101859 (U.S. Publication No. 2004/185326 A1), for example, which has already been cited above and in which the electrolyte layer 2b surrounds the anode 2a and the mesh 3b to make them airtight with respect to the base plate 3a.

A cover element 4 is connected to the cathode 2c, i.e., to the side of the cathode-electrolyte-anode unit 2 facing away from the carrier element 3; this cover element here also consists of a base plate 4a and a mesh 4b supported by the latter. Several passages 5 are provided in this cover element 4 and/or in the base plate 4a thereof as well as in the base plate 3a of the carrier element 3, so that a gas can flow through these passages to the surface of the anode 2a and/or the cathode 2c. It is of course also possible to provide only a single passage 5 into which the aforementioned mesh 3b or 4b, for example, is then inserted.

A first gas stream G in the form of a combustion gas (preferably hydrogen) is brought into proximity of the anode 2a, i.e., either passed by the side of the carrier element 3 facing away from the cathode-electrolyte-anode unit 2 either perpendicular or parallel to the plane of the drawing. A second gas stream L in the form of at least proportional oxygen (preferably air) is brought to proximity of the cathode 2c, i.e., passing it by the side of the cover element 4 facing away from the cathode-electrolyte-anode unit 2 either perpendicular or parallel to the plane of the drawing. The sides where the air-oxygen L and/or combustion gas G is brought into proximity to the cathode-electrolyte-anode unit 2 may of course also be exchanged. Then the cathode becomes the anode and vice versa.

As FIG. 1 shows, at least two but in fact 20 such fuel cells 1, 1′ (etc.), for example, may be arranged with their cathode-electrolyte-anode units 2 side by side, namely in this case in such a way that their cathode-electrolyte-anode units 2, which are spaced a distance apart from one another, essentially describe a common surface, whereby in consideration of two neighboring individual cells 1, 1′, the cover element 4 of the first individual cell 1 is electrically connected to the carrier element 3′ of the second individual cell 1′. In concrete terms, the design is such that in a consideration of two neighboring individual cells 1, 1′, the carrier element 3′ of the second individual cell 1′ (and/or its base plate 3′a) together with the cover element 4 of the first individual cell 1 (and/or its base plate 4a) is designed as a one-piece carrier element-cover element unit, for which the combined identification 3′+4 is used below. Although only the respective so-called base plates 3′a and/or 4a are joined together and/or form a unit, this is still spoken of as a carrier element-cover element unit 3′+4 because the design shown here with a base plate 3′a and/or 4a and a mesh 3′b, 4b arranged thereon is merely optional. The fact that with the embodiment shown here, both the respective carrier elements (3) as well as the respective cover element (4) are each made of a base plate (3a and/or 4a) with a metallic mesh (3b and/or 4b) placed thereon thus has no effect on the advantage of a one-piece carrier element-cover element unit 3′+4 mentioned prior to the description of the figures, said unit being formed by a carrier element 3′ and a cover element 4 of two neighboring individual cells 1, 1′. Without any restriction, the respective mesh 3b and/or 4b may be only applied to or used in the section(s) of the carrier element-cover element unit 3′+4 that is/are actually required, namely to the sections in the area of the cathode-electrolyte-anode unit 2.

To allow a favorable arrangement of the cathode-electrolyte-anode units 2 side by side essentially in a common surface, the carrier element-cover element unit 3′+4 in the exemplary embodiment according to FIG. 1 in the longitudinal section between the two individual cells 1, 1′ shown in the figure, describes a step 11 but in general an offset of any shape is possible at this point. Essentially, the arrangement shown here can also be described by the fact that the cathode-electrolyte-anode units 2, 2′ of the individual fuel cells 1, 1′, . . . which are spaced a distance apart essentially do not overlap with one another in a perpendicular projection according to the direction of arrow P onto the cathode electrolyte anode units 2, 2′.

The carrier element 3 of the first individual cell 1 is designed as a one piece carrier element-cover element unit 3+4″ in a left-side continuation of this chain of individual fuel cells 1, 1′, etc., aligned essentially in a row in a common surface together with the cover element 4″ of an individual fuel cell, which is not otherwise shown but is adjacent to the individual cell 1 in FIG. 1. Similarly, in the right-side continuation of this chain of individual fuel cells 1, 1′, etc., aligned in a row essentially in a common surface, the cover element 4′ of the individual cell 1′ together with the carrier element 3′″ of an individual fuel cell adjacent to the individual fuel cell 1′ at the right in FIG. 1, but not otherwise shown, is designed as a one-piece carrier element-cover element unit 3′″+4′.

However, this one-piece design, as just mentioned, of a cover element 4 (and/or the base plate 4a thereof) of a first individual cell 1 and a carrier element 3′ of a second individual cell 1′ (and/or the base plate 3′a thereof) adjacent thereto is in the form of a one-piece carrier element-cover element unit 3′+4 only with regard to an individual concrete individual cell 1. The carrier element 3 of the first individual cell 1 that is a part of the aforementioned one-piece carrier element-cover element unit 3+4″ may by no means be electrically connected to the one-piece carrier element-cover element unit 3′+4, i.e., to the cover element 4 of the first individual cell 1 and the carrier element 3′ of the second individual cell 1′ because this would result in an electric short circuit of the individual cell and thus the entire fuel cell.

However, to obtain a simple and reliable seal between the two gas flows G and L (the gas stream G is carried, as already explained, on the anode side 2a and therefore below the carrier elements 3 in FIG. 1; the gas stream L, as already explained, is carried on the cathode side 2c and thus above the cover element 4 in FIG. 1), the carrier element 3 of the first individual cell 1 is connected with an airtight connection to the carrier element 3′ of the neighboring second individual cell 1′ (and/or to the corresponding carrier element-cover element unit 3′+4), namely in the area of the aforementioned step 11 or in general in the area of the offset having a suitable design. To this end, the carrier element 3 of the first individual cell 1 is bent essentially in a suitable manner, here in a right angle, on the end facing the neighboring individual cell 1′. The so-called offset of the carrier element-cover element unit 3′+4 of the second individual cell 1′ is also shaped in a suitable manner, whereby the corresponding sections that are to be joined together in an airtight manner run parallel to one another here. With the insertion of an electric insulator 6, this free end section of the carrier element 3 of the first individual cell 1 is connected mechanically in an airtight manner to the carrier element-cover element unit 3′+4 of the neighboring second individual cell 1′ in a manner not shown in greater detail here while at the same time they are electrically insulated from one another. This mechanical connection with the insertion of an insulator 6, shown only schematically here, may be designed in the form of a (conventional per se) flange connection.

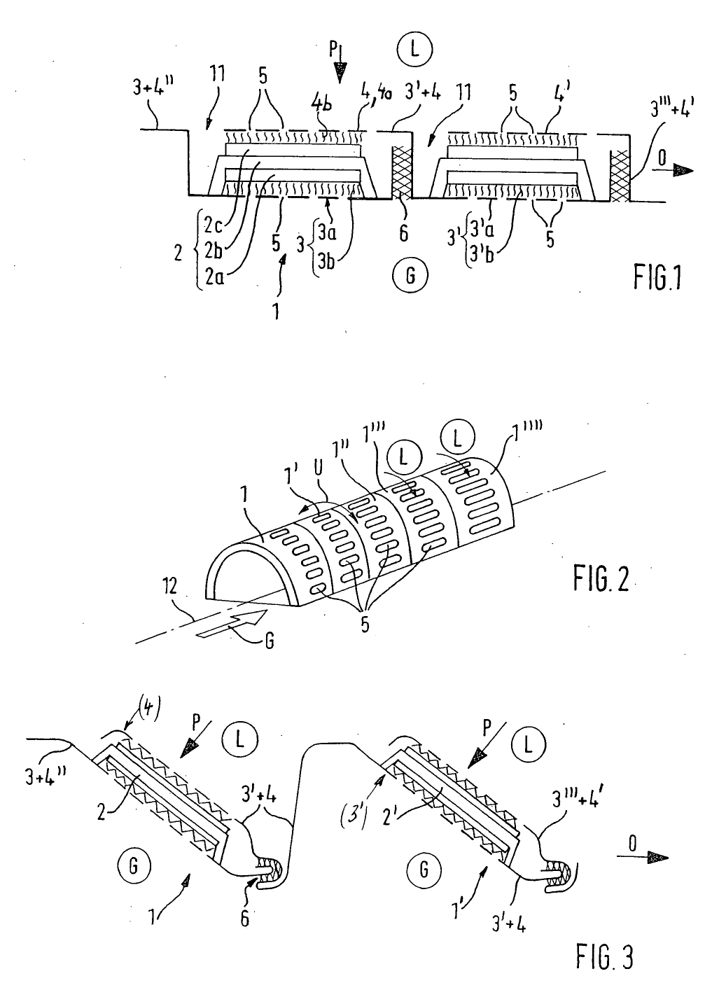

To return to the side by side arrangement of individual fuel cells 1, 1′, etc. to form a fuel cell system, this arrangement according to FIG. 1 may also be described in such a way that here the cathode-electrolyte-anode units 2, 2′ of the two individual cells 1, 1′ are arranged in such a way that in a longitudinal section, i.e., the longitudinal section illustrated in the figure, the anodes and the cathodes of the individual cells arranged side by side yield essentially a structure having a longitudinal orientation in the direction of arrow O, but other arrangements are also possible, so reference is made to the additional exemplary embodiment according to FIG. 3.

In the exemplary embodiment according to FIG. 3, in which the same reference numerals are used for the same elements as in the exemplary embodiment described first (as is fundamentally the case in the present description), several individual fuel cells 1, 1′ connected in series electrically are arranged essentially side by side, so that their cathode-electrolyte-anode units 2, 2 [sic] which are spaced a distance apart essentially do not overlap in a perpendicular projection (according to the direction of arrow P) onto same, whereby in a consideration of two neighboring individual cells 1, 1′, the carrier element 3′ of the second individual cell 1′ is electrically connected to the cover element 4 of the first individual cell 1. FIG. 3 shows only two individual cells 1, 1′ adjacent to one another, but in fact such a chain of individual cells can be continued over a larger number of items. With this arrangement, the advantages described are also achieved in this way, whereby here the area of the mechanical, electrically insulated connection between the carrier element-cover element unit 3′+4 of the second individual cell 1′ to the carrier element-cover element unit 3+4′ of the first individual cell 1 is designed slightly differently than in the exemplary embodiment according to FIG. 1, and whereby a flange connection is shown. However, like the exemplary embodiment according to FIG. 1, there is also a “longitudinal orientation” (illustrated by the arrow O) in the exemplary embodiment according to FIG. 3, making it possible for a stream L of air plus oxygen and a stream G of combustion gas to be passed over the two sides of a chain of individual fuel cells aligned in a row such that the two streams are separated from one another in an advantageous manner, while at the same time a good transfer of heat can be implemented.

To return to FIG. 1 and the linear arrangement of individual fuel cells 1, 1′, etc., also longitudinally oriented according to arrow O, however, a section drawn through an individual cell 1, 1′ perpendicular to the plane of the drawing in FIG. 1 need not show a linear path of the electrode surfaces. Instead, the design may appear as shown in FIG. 2.

FIG. 2 shows in a three-dimensional diagram the top half of a (curved) cylindrical surface in which individual fuel cells 1, 1′, 1″, 1′″, etc. are arranged one after the other, whereby each individual fuel cell is itself designed in the form of a ring. In this diagram, only the respective top halves of the cover elements 4 (and/or 4′, etc.), which are also ring-shaped together with the passages 5 provided in them are visible here of each individual cell 1, 1′, 1″, 1′″, etc. The arrows labeled as L denote a stream of air which is passed over these cover elements 4 of the individual cells 1, 1′, etc., arranged side by side, so that air and/or oxygen can pass through the passages 5 to the cathodes of the individual cells. The arrow labeled with the letter G denotes a stream of combustion gas that is guided within the hollow cylinder formed by the individual fuel cells arranged in this way, namely essentially in the direction of the longitudinal axis 12 and the cylinder. Within this hollow cylinder, the stream G of combustion gas may be carried in the form of a spiral or turbulence may be induced, e.g., with the help of suitably designed guide elements (not shown). The inside wall of this hollow cylinder having the longitudinal axis 12 is thus formed by the carrier elements 3 of the individual fuel cells 1, 1′, 1″, etc., aligned in a row side by side and/or in succession one after the other in the direction of the longitudinal axis 12, whereby the aforementioned passages 5 (not visible and/or not shown in FIG. 2) for the fuel gas G (toward the anodes 2a) are provided in these essentially ring-shaped carrier elements 3 and/or in the base plates 3a thereof.

In FIG. 2, the passages 5 (here only for the air-oxygen stream L) are shown, but in this exemplary embodiment the cathodes 2c and/or anodes 2a are shaped, i.e., within each individual cell 1 and/or 1′, etc., the cathode-electrolyte-anode units 2 are applied over the area partially to the carrier element 3 in such a way that a plurality of segments of individual cells aligned in a row can be seen in the circumferential direction U of each ring-shaped individual cell 1, 1′, etc. For the sake of simplicity, this is not shown in detail, but the individual segments of individual cells are essentially shaped and designed as indicated by the passages 5 shown in the figure. This principle of the partial subdivision of the surface of a fuel cell individual cell into multiple individual cell segments in a perspective diagram is shown in FIG. 5 again for a “planar” fuel cell system, i.e., a fuel cell system that is not shaped to form a hollow body, where the direction of arrow O denotes the so-called “longitudinal orientation” (see FIGS. 1, 3) and the direction of arrow U corresponds to the circumferential direction according to FIG. 2. In FIG. 5, like FIG. 1, two carrier element-cover element units 3′+4, 3+4″ arranged side by side can be seen with the corresponding passages 5 provided in the carrier element 3′ and in the cover element 4. Furthermore, the cathode-electrolyte-anode unit 2 (=fuel cell) of the individual cell 1 and/or the proximal segment thereof can be seen. With the “segmentation” of the cathode-electrolyte-anode units 2, i.e., partial application thereof to the surface of the carrier element 3, it is possible to avoid problems that would otherwise occur due to thermal stresses. This measure also serves to reduce mechanical stresses inside the cathode-electrolyte-anode units 2.

Returning now to FIG. 2, it can be seen that in a comparison of several individual fuel cells, the length of the passages 5 increases in the direction of flow of the combustion gas stream G. As mentioned previously, the length of the segments of the individual fuel cells aligned in a row thus also increases and therefore the surface area of the segment and the effective surface area of the individual cells 1, 1′, etc. also increase in the direction of flow G of the combustion gas stream. With this measure, the concentration of the combustion gas stream G, which decreases in said direction of flow, is compensated. The individual cells situated “farther toward the rear” in the direction of flow thus have a larger reactive surface area in view of the decreasing concentration of the combustion gas flow G.

A comparable effect can be achieved with a different design according to the exemplary embodiment shown in FIG. 6 where the fuel cell system is not designed in the form of a hollow cylinder as in FIG. 2 but instead in the form of a hollow cone with a cross section that increases in the direction of flow of the combustion gas stream G. Since the surface area of the cone thus increases in the direction of flow G of the combustion gas, the surface area of the individual fuel cells 1, 1′, 1″, etc., aligned in a row also increases in the direction of flow G, so that again compensation of the declining concentration of combustion gas G in the direction of flow is possible. The increasing surface area can be utilized to increase the number of segments of the individual cells in the direction of flow G—as illustrated in the figure or to increase the dimension of the individual segments in the circumferential direction U (not shown here) as seen in the direction of flow G.

Whereas FIG. 2 shows how the combustion gas stream G can be guided along the fuel cell system and/or along the carrier elements 3 thereof, this is not shown in FIG. 2 for the second gas stream and/or air-oxygen stream L which is guided along the cover elements 4. Although theoretically a specific guidance for this air stream L is not necessary, nevertheless such guidance should be provided not only to promote an incoming flow of fresh oxygen and/or unspent air but also, for example, to prevent heavy soiling of the fuel cell system.

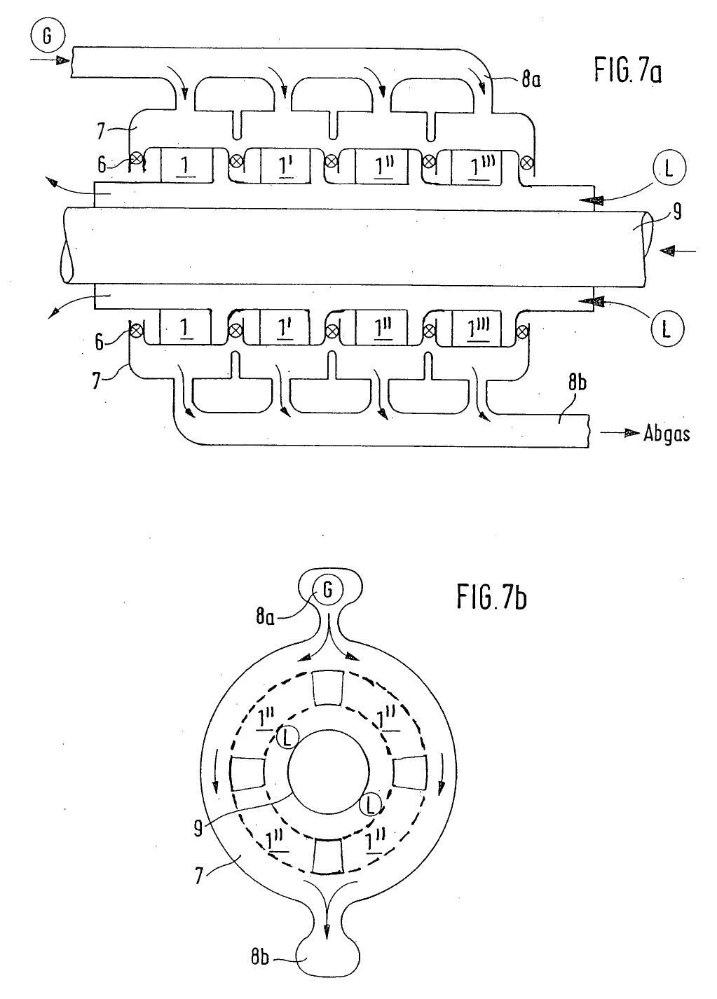

FIGS. 7a, 7b show in principle one possible embodiment with a bordering wall 7 and a gas supply system 8a connected thereto and a gas removal system 8b, whereby the bordering wall 7 here surrounds four individual fuel cells 1, 1′, 1″, 1′″ arranged side by side in a shared circular cylindrical surface. The bordering wall 7 carrying the combustion gas stream G more or less on the outside along the surface of the individual cells and surrounding the circular cylindrical individual cells 1, 1′, etc., is also designed to have a circular cylindrical shape, adapted to the circular cylindrical individual cells. In the upper areas in FIGS. 7a, 7b, feed openings assigned to the individual cells 1, 1′, etc., are provided in the bordering wall 7 so that the combustion gas stream G supplied by gas supply system 8a can reach via these feed openings into the interior space which is surrounded by the bordering wall 7 and thus can reach the individual cells. Similarly the so-called exhaust gas that is burned is removed from the lower area in FIGS. 7a, 7b via a gas removal system 8b.

The airtight and mechanical connection between the bordering wall 7 and the respective carrier element-cover element units may be designed here like that between two neighboring carrier element-cover element units, i.e., with an intermediate suitable electric insulator 6 in the connecting area, which may be designed in the form of a flange connection (not shown), for example. Moreover, a similar bordering wall may also be provided on the other side of the cathode-electrolyte-anode units 2, i.e., here in the area of the feed stream of the air-oxygen gas stream L, not only in the case of another structural embodiment and/or arrangement of individual fuel cells 1, 1′ in which although they continue to form a common surface, they do not form a closed cylindrical surface. Instead, in an arrangement of the individual fuel cells 1, 1′, etc., on a cylindrical surface or conical surface and a hollow cylinder or hollow cone thereby formed by analogy with FIG. 2 or FIG. 6 in the interior of same spaced a distance away in the radial direction from the individual cells, a cylindrical or conical bordering wall may be provided within or along which a medium is passed on the side opposite the individual cells, with the help of which the fuel cell system can be heated or cooled, i.e., thermally regulated in a generally suitable manner. Such a bordering wall, designed here as a tube within which is carried a medium suitable for thermal regulation, is labeled with reference numeral 9 in FIGS. 7a, 7b. The air-oxygen gas stream L is guided here between this bordering wall 9, i.e., between the outside wall of this tube and the individual fuel cells 1, 1′, etc., that are aligned in row.

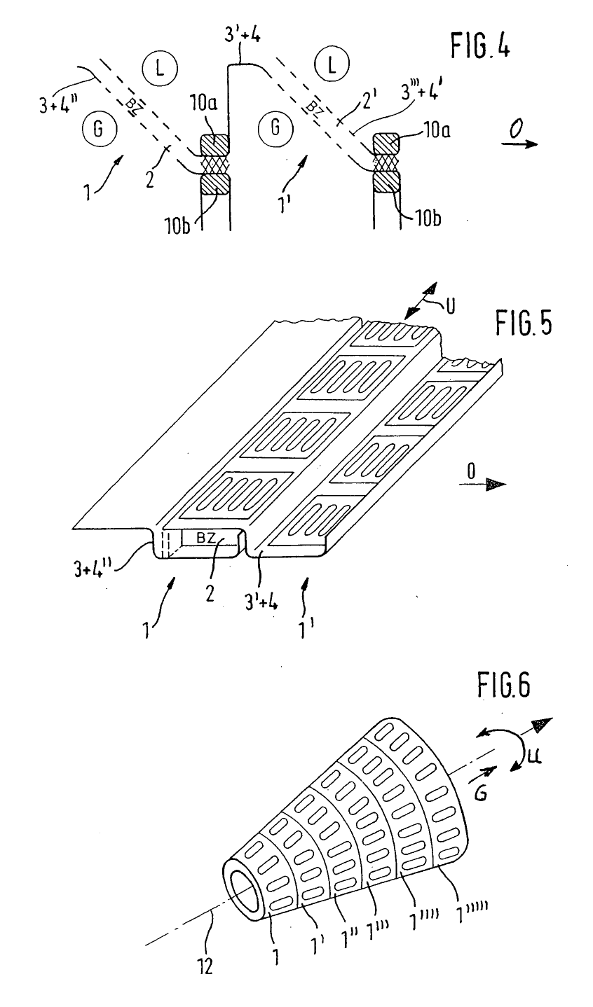

With reference now to FIG. 4, a mechanical connection is shown between the carrier element-cover element units of neighboring individual fuel cells, arranged as shown in FIG. 3, differing from the exemplary embodiment according to FIG. 1. The carrier [element]-cover element units 3′+4 and 3+4″ are shaped in the connecting area here so that they extend and overlap in the direction of the longitudinal orientation 0. In particular even when this fuel cell system is still designed like that in FIG. 2, i.e., in the form of a circular cylinder in general or a rotationally symmetrical hollow body having the longitudinal axis 12, the mechanical connection between two neighboring carrier element-cover elements units (4+3′, 3+4″) may be embodied in the form of partial overlapping with the elements secured by a tensioning belt l0a or the like, optionally in conjunction with a rotational symmetrical supporting element 10b. The tension belt 10a here surrounds the so-called overlap area of the carrier element-cover element units, which are in turn supported on the supporting element 10b arranged within same in this overlap area.

A fuel cell system according to the present documents may preferably be used in combination with an internal combustion engine that functions as the drive unit of a motor vehicle, whereby the fuel cell system is connected in a heat transfer connection to the exhaust system and/or the exhaust gases of the internal combustion engine. Then the internal combustion engine exhaust gases can be passed directly through the tubular bordering wall 9 illustrated in FIGS. 7a, 7b in an especially simple manner.

Not shown in the figures is an advantageous further embodiment, which is explained before the description of the exemplary embodiments, according to which measures are provided on the cover elements 4 (and/or carrier elements 3) of the cathode-electrolyte-anode units 2 facing the air-oxygen gas stream L, in particular to increase the electric conductivity, e.g., by applying a suitable highly conductive layer to these elements. This makes it possible in the best feasible way to reduce the electric resistance in the fuel cell system, which can assume a high value because of the great strength requirements of the material of which these elements are made. Numerous other details may of course be implemented in a manner that deviates from the above discussion without going beyond the scope of the invention in the appended claims. For example, when in the case of another structural embodiment and/or arrangement of individual fuel cells 1, 1′ in which they have a common surface but each one separately does not form a closed cylindrical surface, a suitable airtight seal may be required on the front and rear edges of the respective individual fuel cells 1, 1′, etc., in a consideration of FIGS. 1 and 3 in the direction perpendicular to the plane of the drawing. Again in the case of an arrangement of the individual fuel cells on a cylinder or cone (as shown FIGS. 2, 6), several such rotationally symmetrical hollow bodies arranged concentrically with one another may also be provided.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A fuel cell system comprising several individual fuel cells connected in series electrically, each fuel cell having a cathode-electrolyte-anode unit arranged between an electrically conducting carrier element and an electrically conducting cover element, with a side facing the carrier element that is acted upon by a first gas and a side facing the cover element that is acted upon by a second gas, wherein the individual cells connected in series electrically are arranged side by side and are spaced a distance apart from one another so that their cathode-electrolyte-anode units do not overlap, and wherein for adjacent fuel cells, the cover element of one individual cell is electrically connected to the carrier element of the adjacent individual cell, and wherein the surface areas of the cathode-electrolyte-anode units of successive following individual cells increase in the direction of flow of the combustible gas stream.

2. The fuel cell system of claim 1, wherein the cathode-electrolyte-anode unit is applied partially to the surface of the carrier element.

3. The fuel cell system of claim 1, wherein a mechanical connection between two neighboring carrier element-cover element units and/or between a carrier element-cover element unit and a gas-carrying bordering wall is configured in the form of a flanged edge.

4. The fuel cell system of claim 1, wherein a mechanical connection between two neighboring carrier element-cover element units and/or between a carrier element-cover element unit and a gas-carrying bordering wall is configured in the form of a partial overlap which is secured.

5. The fuel cell system of claim 4, wherein the partial overlap is secured by a tension belt.

6. The fuel cell system of claim 1, wherein a mechanical connection between two neighboring carrier element-cover element units and/or between a carrier element-cover element unit and a gas-carrying bordering wall is provided with a supporting element.

7. The fuel cell system of claim 1, wherein measures to increase the electric conductivity are provided on the cover elements or carrier elements of the cathode-electrolyte-anode units facing the respective gas streams.

8. The fuel cell system of claim 1, wherein said fuel cell system forms a substantially flat planar surface.

9. The fuel cell system of claim 1, wherein said fuel cell system is configured in the form of a cylinder.

10. The fuel cell system of claim 1, wherein said fuel cell system is configured in the form of a cone.

11. The fuel cell system of claim 1, wherein the fuel cells are arranged at an inclination relative to a longitudinal direction of the fuel cells side by side.

12. A fuel cell system comprising several individual fuel cells connected in series electrically, each fuel cell having a cathode-electrolyte-anode unit arranged between an electrically conducting carrier element and an electrically conducting cover element, with a side facing the carrier element that is acted upon by a first gas and a side facing the cover element that is acted upon by a second gas, wherein the individual cells connected in series electrically are interleaved to resemble an arrangement of roofing tiles in a longitudinal direction and are spaced a distance apart from one another and wherein for adjacent fuel cells, the cover element of one individual cell is electrically connected to the carrier element of the adjacent individual cell, and wherein the surface areas of the cathode-electrolyte-anode units of successive following individual cells increase in the direction of flow of the combustible gas stream.

13. The fuel cell system of claim 12, wherein the cathode-electrolyte-anode unit is applied partially to the surface of the carrier element.

14. The fuel cell system of claim 12, wherein a mechanical connection between two neighboring carrier element-cover element units and/or between a carrier element-cover element unit and a gas-carrying bordering wall is configured in the form of a flanged edge.

15. The fuel cell system of claim 12, wherein a mechanical connection between two neighboring carrier element-cover element units and/or between a carrier element-cover element unit and a gas-carrying bordering wall is configured in the form of a partial overlap which is secured.

16. The fuel cell system of claim 15, wherein the partial overlap is secured by a tension belt.

17. The fuel cell system of claim 12, wherein a mechanical connection between two neighboring carrier element-cover element units and/or between a carrier element-cover element unit and a gas-carrying bordering wall is provided with a supporting element.

18. The fuel cell system of claim 12, wherein measures to increase the electric conductivity are provided on the cover elements or carrier elements of the cathode-electrolyte-anode units facing the respective gas streams.

19. The fuel cell system of claim 12, wherein said fuel cell system forms a substantially flat planar surface.

20. The fuel cell system of claim 12, wherein said fuel cell system is configured in the form of a cylinder.

21. The fuel cell system of claim 12, wherein said fuel cell system is configured in the form of a cone.

22. The fuel cell system of claim 12, wherein the fuel cells are arranged at an inclination relative to the longitudinal direction of the arrangement of fuel cells.

23. An internal combustion engine comprising a fuel cell system as set forth in claim 1, wherein the fuel cell system is connected to the exhaust system and the exhaust gas of the internal combustion engine in a heat transfer connection.

24. The internal combustion engine of claim 23, wherein said internal combustion engine is a driving unit of a motor vehicle.
